(19) United States
(12) Patent Application Publication
(10) Pub. No.: US 2017/0344198 A1
(43) Pub. Date: Nov. 30, 2017

(54) SERVICE REQUEST SYSTEM

(71) Applicant: DISPENSING DYNAMICS INTERNATIONAL, City of Industry, CA (US)

(72) Inventors: Joel P. Keily, Corona, CA (US); Richard Dale Brannan, JR., Diamond Bar, CA (US); Charles Parkin Davis, Torrance, CA (US)

(73) Assignee: Dispensing Dynamics International

(21) Appl. No.: 15/259,235

(22) Filed: Sep. 8, 2016

Related U.S. Application Data
(60) Provisional application No. 62/217,072, filed on Sep. 11, 2015.

(51) Int. Cl. G06F 3/0482; G06F 3/0484; G06Q 50/12; G06F 3/01; G06F 3/0481

(52) U.S. Cl. CPC G06F 3/0482; G06Q 50/12; G06F 3/017; G06F 3/0484; G06F 3/04817

(57) ABSTRACT

A system allowing a user to communicate with a service provider concerning services includes a user interface panel indicating restroom maintenance services available and communication structure through which a user can select required services and communicate with the service provider.

This application is based on and claims the benefit of U.S. Provisional Patent Application No. 62/217,072, filed Sep. 11, 2015.

### TECHNICAL FIELD

This invention relates to a service request system including an apparatus and a method for establishing communication between a user of a service and a service provider. The invention disclosed herein relates to restroom maintenance services but the invention is applicable in other fields.

### BACKGROUND OF THE INVENTION

It is known generally to utilize communication systems of various types to allow communication to be delivered electronically between individuals, such as hotel guests, and janitors or other maintenance service personnel.

The following patent documents are known and are believed to represent the current state of the art in this general field: U.S. Pat. No. 8,364,546, issued Jan. 29, 2013, U.S. Pat. No. 7,990,267, issued Aug. 2, 2011, U.S. Pat. No. 7,225,037, issued May 29, 2007, U.S. Pat. No. 7,115,856, issued Oct. 3, 2006, U.S. Pat. No. 6,819,238, issued Nov. 16, 2004, U.S. Pat. No. 5,926,111, issued Jul. 20, 1999, U.S. Pat. No. 5,594,409, issued Jan. 14, 1997, U.S. Pat. No. 5,594,238, issued Jan. 14, 1997, U.S. Patent App. Pub. No. US2014/0359677, published Dec. 4, 2014, U.S. Patent App. Pub. No. US 2013/0099930, published Apr. 25, 2013 and U.S. Patent App. Pub. No. US 2006/0161270, published Jul. 20, 2006.

### DISCLOSURE OF INVENTION

The system of the present invention is characterized by its relative simplicity, ease of use and reliability. The system achieves the goal of providing and keeping a high level of user convenience and incorporates an electric energy conservation feature.

In a preferred embodiment of the apparatus of the invention, a user interface panel is located at or in relatively close proximity to a light switch. The panel will communicate when necessary with a wireless node strategically located somewhere within the facility where the restroom is located and a computer.

Other features, advantages and objects of the present invention will become apparent with reference to the following description and accompanying drawings.

### BRIEF DESCRIPTION OF DRAWINGS

FIG. 1 is a front elevation view of a wall mounted user interface panel employing two communication controls and a standard light switch;

FIG. 2 is a view similar to FIG. 1, but illustrating the user interface panel displaying that the two communication controls are in operational states differing from the operational states displayed in FIG. 1;

FIG. 3 is a front, elevational view of a second embodiment of wall mounted user interface panel with two communication controls, but not including a separate light switch;

FIG. 4 is a block diagram illustrating the wall mounted user interface panel embodiment of FIGS. 1 and 2 in operative association with other system components;

FIG. 5 is a block diagram showing a local system constructed in accordance with the teachings of the present invention;

FIG. 6 is a block diagram of a world wide access system constructed in accordance with the teachings of the present invention;

FIG. 7 is a front elevation view similar to FIG. 1 showing an alternative user interface panel employing two communication controls, but not including a light switch;

FIG. 8 is a view similar to FIG. 7 illustrating a service required by means of an arrow an icon on the user interface panel being selected by a user;

FIG. 9 is a view similar to FIG. 8 illustrating a light at the service required icon selected by a user notifying selection and activation thereof;

FIG. 10 illustrates reset of the panel to the condition of FIG. 8 showing the light extinguished upon clearing by a restroom maintenance worker to indicate completion of the service; and

FIG. 11 is a block diagram of an alternative local access configuration.

### MODES FOR CARRYING OUT THE INVENTION

The apparatus and method of the service request system of this invention are applicable to many different situations and fields wherein communication is provided between a user of services and providers of the services. An exemplary application is disclosed herein wherein the apparatus and method of this invention are employable in restrooms or other locations near restrooms to indicate to maintenance service providers, such as the maintenance staff of a hotel, that a service of some kind is needed with respect to the restroom.

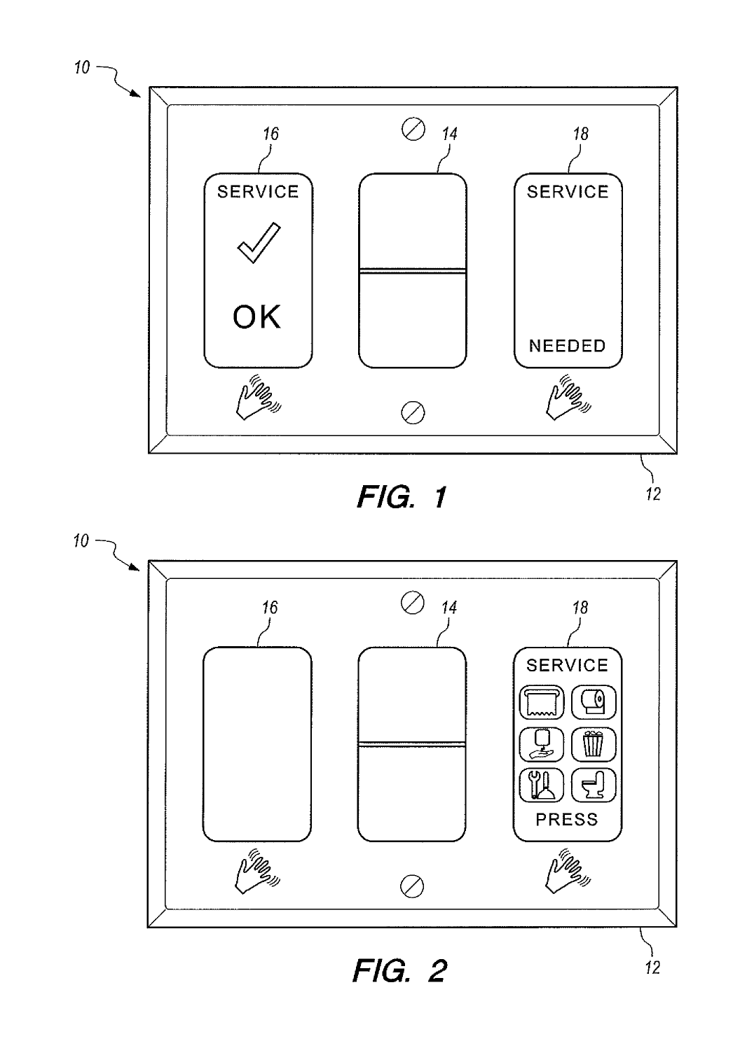

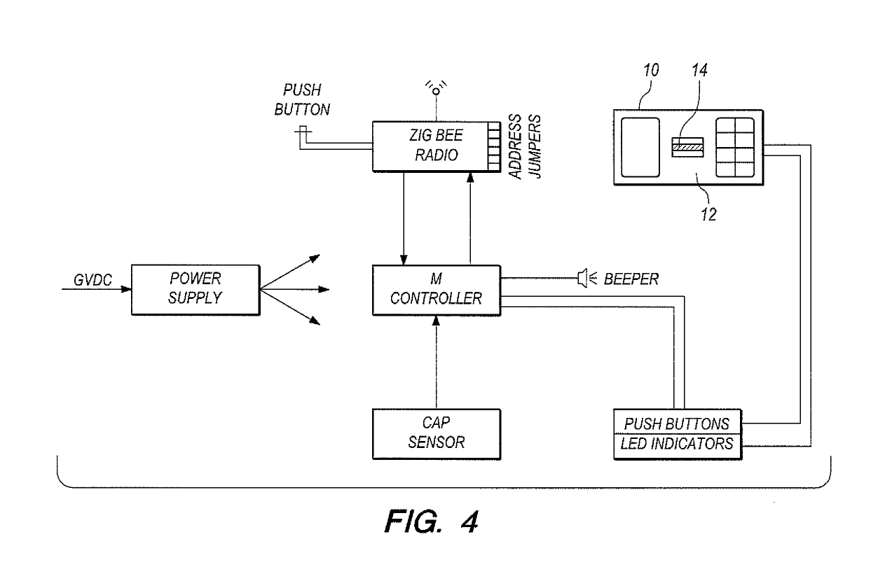

FIGS. 1 and 2 illustrate a wall mounted user interface panel 10 constructed in accordance with the teachings of the present invention. The panel 10 will communicate when necessary with a wireless node located somewhere strategically within the facility in which the restroom is located and a computer. FIG. 4 shows wall mounted faceplate 12 of a user interface panel and other system components in operable association therewith.

The user interface panel 10 is employed with a standard light switch 14 which is received in an aperture of the faceplate 12. The user interface panel has two communication controls including faceplate portions 16, 18. Faceplate portion 16 has indicia thereon relating to actuation of the system. Faceplate portion 18 has indicia thereon not readily observable unless backlit relating to the service or services needed.

When a service is needed within the restroom, the user, who could be anyone using or planning use of the restroom, waves a hand or other object in near proximity to faceplate portion 16. A cap sensor switch operatively associated with faceplate portion 16 causes back lighting of faceplate portion 18 to illuminate icons thereon as shown in FIG. 2. The faceplate portion 18 has membrane actuated switches operatively associated therewith which are actuated when icons on faceplate portion are pressed. The selected icons will be illuminated by LEDs, for example, red. The user can select one or more icons. A beeper will make a sound when the cap sensor is triggered and when the membrane switches are pressed. Electrical energy consumption is maintained at a lower level until the service needed switch is activated. A battery can be used to power the panel or external power, such as by an AC/DC wall adaptor, may be utilized. Rather than employ membrane actuated switches, push button switches with icons could be utilized.

Upon completion of the service selection a wireless transmission of a coded message is forwarded to a main computer. This may be for example accomplished by a Zigbee protocol radio as shown in FIG. 4 through router and coordinator nodes. Using Zigbee, the node information is then displayed on the computer screen and is optionally sent to a user selectable cell phone as an SMS message or as an internet message, such as TCP/IP. The computer sends a message via the same pathway back to the originating panel that service is pending. This will cause the selected service button LEDs to blink. After the services required are completed, a message is sent from the computer to the user interface panel clearing the “service needed” status and all blinking LED indications.

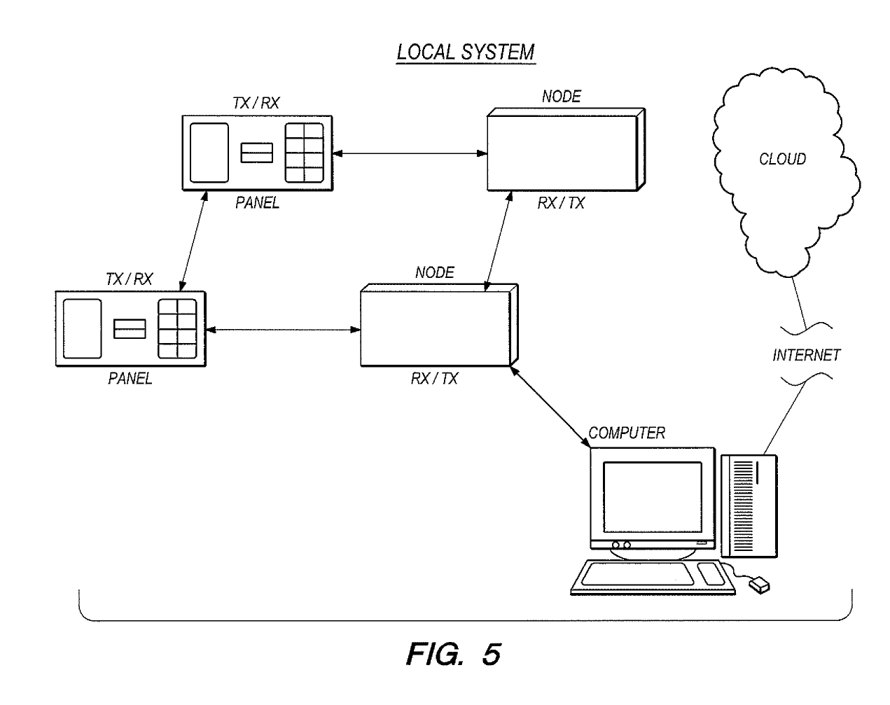

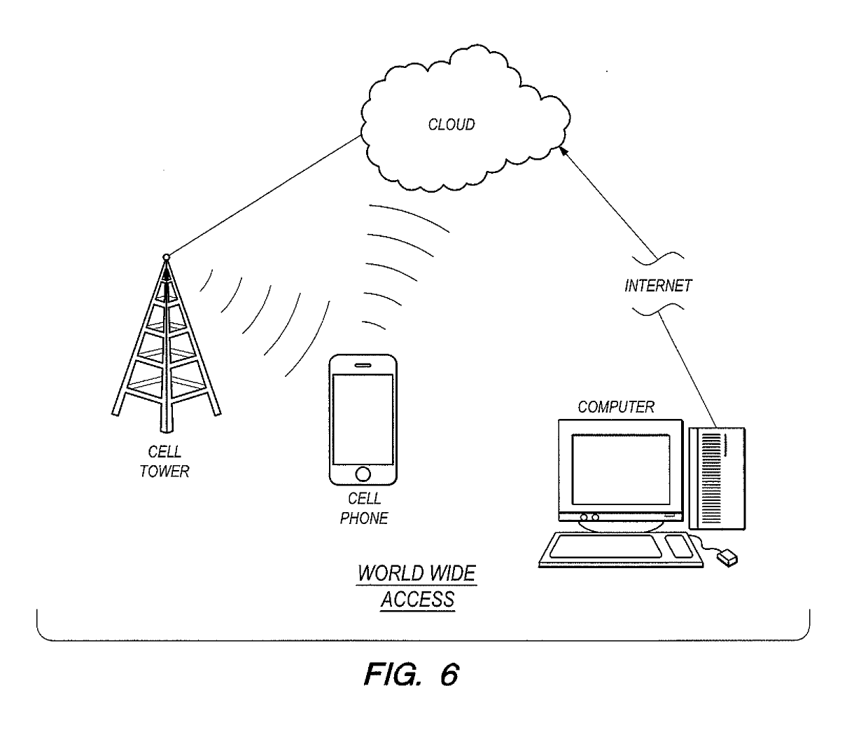

FIGS. 5 and 6 respectively show a local system configuration and a world wide access configuration, the latter employing internet cloud connection with a computer and a cell phone. Using Zigbee, the node nearest the computer would be a coordinator, and the other node would be a router, extending the range of the coordinator. A router is not always required if the panel is within the range of the coordinator.

With respect to the local system, an internet cloud connection may also be utilized. In the local system many user interface panels may be utilized in the system. It is preferred that a Zigbee self healing mesh protocol be utilized. For power savings, a low power radio is utilized, and the radio is only powered as needed.

The panel may incorporate a wireless transmission sleep mode to save power. It will wake up as needed to respond to service requests. The panel may be programmed to send a supervision signal occasionally, possibly every 1 to 24 hours, so that the computer will know that it and the wireless network are functioning.

As mentioned above, user selectable service request may be via key pad buttons/icons. The panel may be powered by an external power supply or batteries. The panel may be wall mountable or light switch junction box mountable.

As shown in FIG. 4, installer address selection jumpers are utilized for unique identification to main system. A beeper in the form of a buzzer enunciator may be employed along with multi-purpose LED enunciators.

A push button is employed to associate radio and join system.

A beeper makes a sound whenever the cap sensor is triggered and subsequently when the membrane actuated switches, or push buttons are pressed.

Capacitive proximity sensing may be provided to exclusively maintain “no touch use”.

The operation of an embodiment of the invention may be generally and briefly summarized as follows:

In Steady State, the wireless transmitter of the device (the “Panel”) is off and the device is active.

A hand wave turns on user interface via a capacitive sensor or other electronic sensor. User input is provided via interface.

The device wirelessly sends a signal to a computer via a node after user input or optionally when wave activates the user interface.

Software will reset the system (Clear the requests on the specific wall plate).

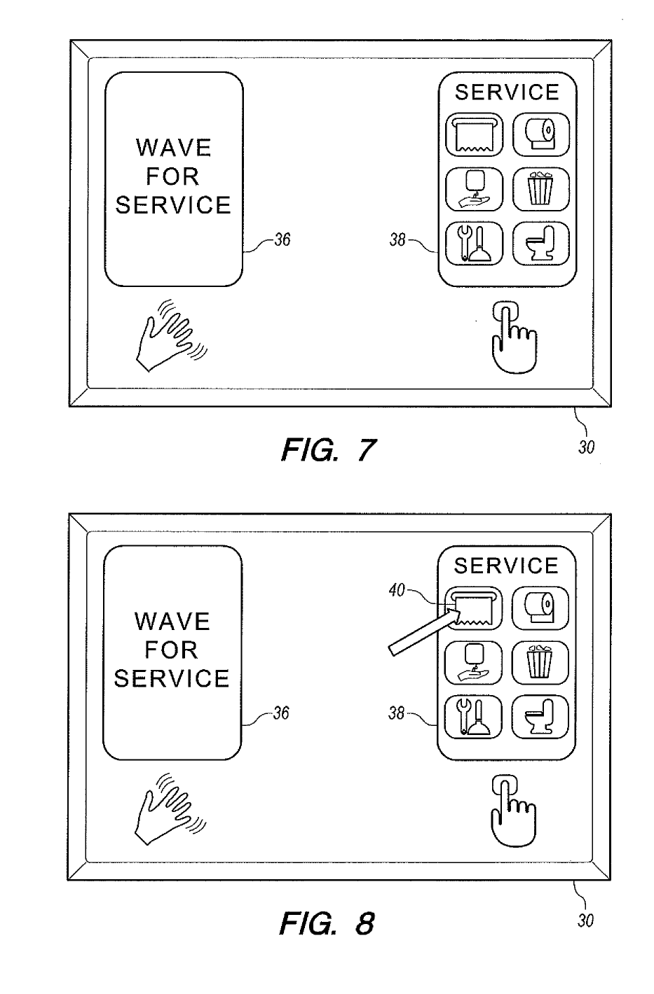

FIGS. 7-10 illustrate a faceplate in the form of user interface panel 30, suitably a touch panel, having two communication controls including portions 36, 38.

Portion 36 has indicia thereon relating to actuation of the system. Portion 38 has indicia thereon relating to the service or services required.

In this embodiment the indicator may be readily visible at all times, whether there is a back light or not. Referring now to FIG. 7, the user interface panel is in stand by mode. When the user's hand is raised over portion 36, the back panel “wakes” up. There are no visible lights if the panel is in stand-by mode and there are no service requests pending.

Next, the user selects a service required icon 40, one of the icons indicated by portion 38, as shown by the arrow in FIG. 8.

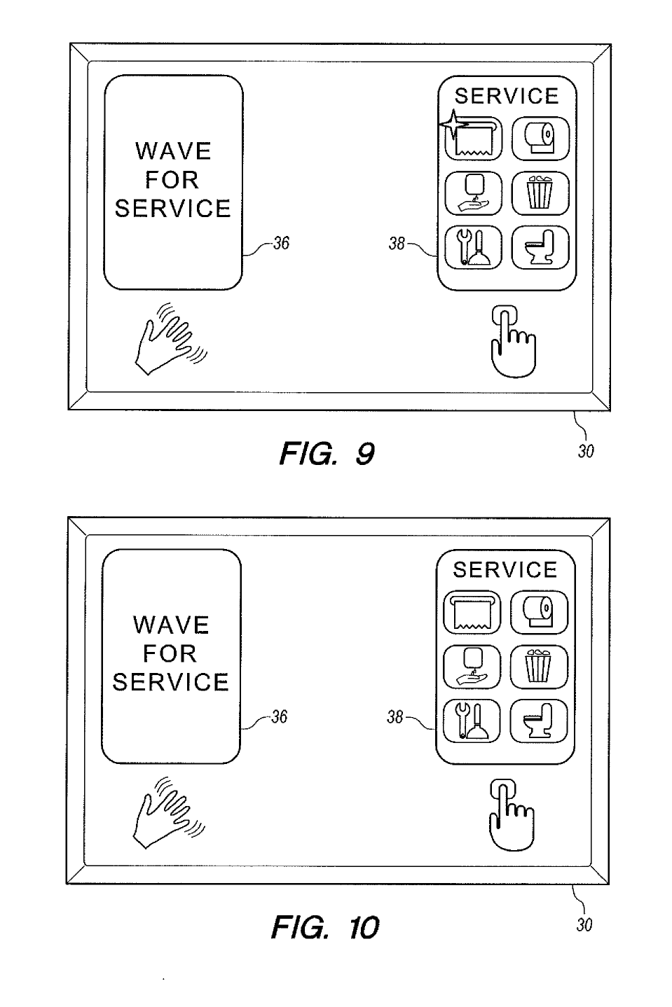

A membrane switch is incorporated with each icon of portion 38. An LED will light up for each service requested. Other types of sensor switches, including for example capacitance sensor switches, may be utilized. Preferably, the service required indicator will blink at a set rate until the panel is reset. In FIG. 9, for example, the top left service icon is blinking.

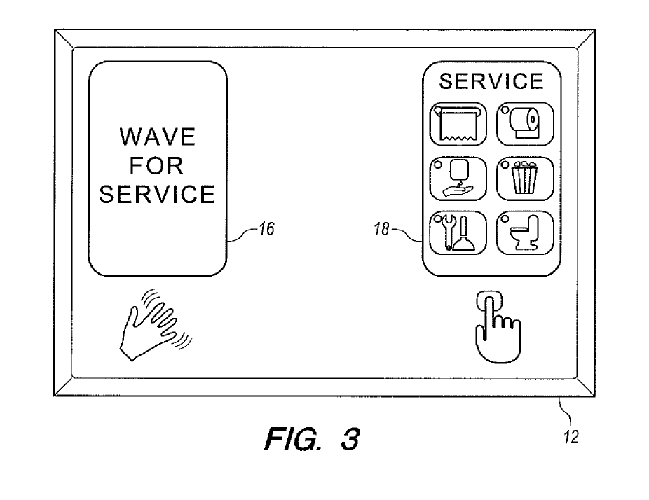

In the arrangement of FIGS. 1-6 described above, once service has been provided in connection with prior selected services, each individual service completed was cleared from the panel by a computer and software.

In the subject arrangement now under discussion, clearing may be readily accomplished by the janitor or other party upon completion of the service by pressing a secret button incorporated in the device and entering a passcode. This could be done by having the janitors enter their passcodes when they get to and when they leave a restroom.

When a panel is powered by an external power supply (not batteries), the panel will not sleep the radio so that it can also be a router. The other functions will work as they do when on battery power.

The communication between panel to panel is just to get the message to the computer. The panels do not talk to each other.

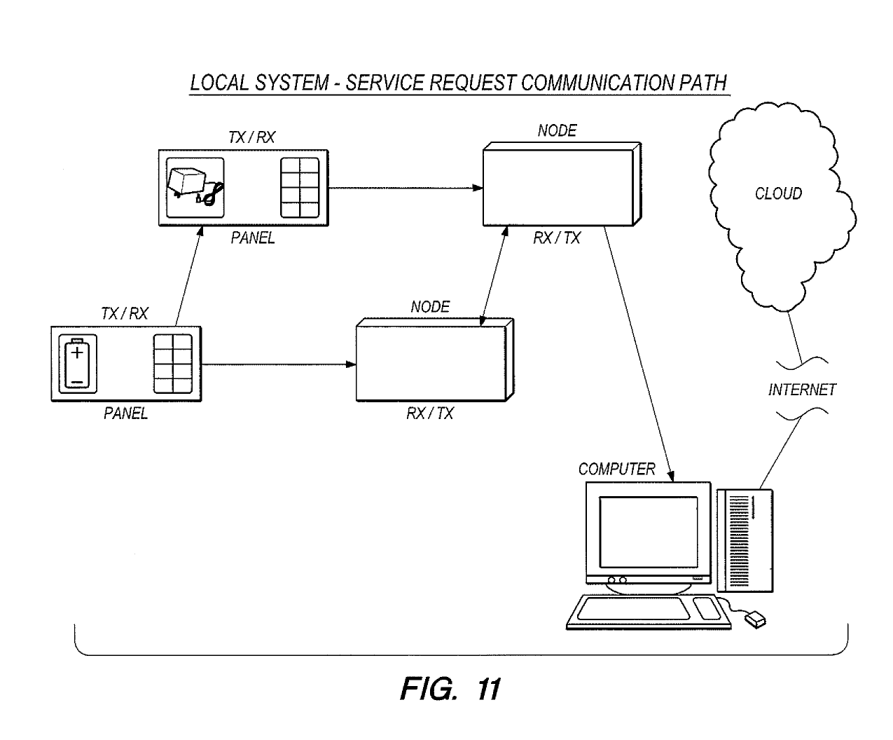

FIG. 11 is a block diagram presentation of the service request communication path when utilizing the structure of FIGS. 7-10.

It will be appreciated that apparatus of the present invention may utilize different types of switches, including types of sensors instead of mechanical switches. First actuation may be accomplished by using a capacitance proximity sensor and the service selector using capacitance touch sensors.

The invention claimed is:

1. Apparatus employable to indicate to a service provider that service is needed at a location spaced from said service provider, said apparatus comprising:
a user interface panel for positioning at or adjacent to said location, said user interface panel having first indicia thereon relating to actuation of the apparatus and further having second indicia thereon relating to the nature of services available, said first indicia responsive to movement of a hand or object by a user to actuate the apparatus and allow the user to select one or more of the services displayed by the second indicia;
a communications structure in operative association with said user interface panel for communicating said selected one or more services to the service provider; and
a clearing apparatus operatively associated with said user interface panel to clear said selected one or more services from said user interface panel.

2. The apparatus according to claim 1 wherein said clearing apparatus includes a suitably programmed computer operatively associated with said user interface panel.

3. The apparatus according to claim 2 wherein said user interface panel communicates with said suitably programmed computer through a wireless mode.

4. The apparatus according to claim 1 wherein said communications structure includes a plurality of switches operatively associated with said second indicia, a different switch utilized in connection with each of said services displayed by the second indicia.

5. The apparatus according to claim 1 wherein said user interface panel includes a first face plate portion having said first indicia responsive to a wave of a hand or object by the user to actuate the apparatus and allow the user to select one or more of the services displayed by the second indicia on a second face plate portion of said user interface panel.

6. The apparatus according to claim 5 wherein said second indicia includes a service actuation icon operable to indicate to a user that displayed services on said second face plate portion are available for selection.

7. The apparatus according to claim 4 including LEDs associated with said plurality of switches to indicate which of said services have been selected by the user.

8. The apparatus according to claim 1 wherein said services are restroom maintenance services.

9. The apparatus according to claim 1 selectively operable either from an internal power source or by external power, the apparatus including a router actuated when powered externally.

10. A method for indicating to a service provider that service is needed at a location, said method including the steps of:
positioning a user interface panel at or adjacent to said location, said user interface panel including first indicia and second indicia, said first indicia relating to actuation of the apparatus and said second indicia thereon relating to the nature of services available, said first indicia responsive to movement of a hand or object by a user to actuate the apparatus and allow the user to select one or more of the services displayed by the second indicia;
providing a communications structure in operative association with said user interface panel for communicating said selected one or more services to the service provider; and
operatively associating a clearing apparatus with said user interface panel to clear said selected one or more services from said user interface panel.

11. The method according to claim 10 wherein said clearing apparatus includes a suitably programmed computer operatively associated with said user interface panel.

12. The method according to claim 9 wherein said user interface panel communicates with said suitably programmed computer through a wireless mode.

13. The method according to claim 10 wherein said communications structure includes a plurality of switches operatively associated with said second indicia, a different switch utilized in connection with each of said second indicia.

14. The method according to claim 10 wherein said user interface panel includes a first face plate portion having said first indicia displayed responsive to a wave of a hand or object by the user to actuate the apparatus and allow the user to select one or more of the services displayed by the second indicia on a second face plate portion.

15. The method according to claim 10 wherein said second indicia includes a service actuation icon operable to indicate to a user that displayed services on said second face plate portion are available for selection.

16. The method according to claim 13 including LEDs associated with said plurality of switches to indicate which of said services have been selected by the user.

17. The method according to claim 10 wherein said services are restroom maintenance services.

18. The method according to claim 10 selectively operable either from an internal power source or external power, the method including a router actuated when powered externally.
